(19) United States
(12) Patent Application Publication
(10) Pub. No.: US 2026/0310238 A1
(43) Pub. Date: Oct. 8, 2026

(54) ANTI-FALLING APPARATUS, TRANSPORT ROBOT, AND ANTI-FALLING DEVICE

(71) Applicant: HAI ROBOTICS CO., LTD., Shenzhen (CN)

(72) Inventor: Kejun NING, Shenzhen (CN)

(73) Assignee: HAI ROBOTICS CO., LTD., Shenzhen (CN)

(21) Appl. No.: 19/680,847

(22) Filed: May 18, 2026

Related U.S. Application Data
(63) Continuation of application No. PCT/CN2024/132404, filed on Nov. 15, 2024.

(30) Foreign Application Priority Data
Nov. 30, 2023 (CN) 202311636083.9

(51) Int. Cl. G05D 1/80; B66F 9/075; B66F 17/00; G05D 105/28; G05D 107/70; G05D 111/50

(52) U.S. Cl. CPC G05D 1/80; B66F 9/07509; B66F 17/00; G05D 2105/28; G05D 2107/70; G05D 2111/52

(57) ABSTRACT

An anti-falling apparatus is used in a transport robot. The transport robot can ascend or descend vertically along a rack rail. The transport robot includes a braking mechanism. The anti-falling apparatus includes: an acceleration measurement unit configured to measure an acceleration of the transport robot; and a control unit, configured to obtain the acceleration, and further configured to detect, according to the acceleration, whether the transport robot falls on the rack rail, and when detecting that the transport robot falls on the rack rail, control the braking mechanism to apply braking, to stop the transport robot from falling.

### CROSS-REFERENCES

This application is a continuation of International Patent Application No. PCT/CN2024/132404 filed on Nov. 15, 2024, which claims priority to Chinese Patent Application No. 202311636083.9, filed with the China National Intellectual Property Administration on Nov. 30, 2023 and entitled “ANTI-FALLING APPARATUS, TRANSPORT ROBOT, ANTI-FALLING METHOD AND DEVICE, AND STORAGE MEDIUM”, the disclosures of which are incorporated herein by reference in their entireties.

### TECHNICAL FIELD

Embodiments of this application relate to the field of intelligent warehousing technologies, and specifically, to an anti-falling apparatus, a transport robot, and an anti-falling device.

### BACKGROUND OF THE INVENTION

In an existing warehousing system, a rack includes a plurality of levels and a plurality of columns of storage locations for storing cases. Generally, a transport robot is used to retrieve the cases stored at the storage locations, or to transport and store the cases at the storage locations. Transverse rails and vertical rails may be arranged on the rack. The transport robot moves transversely or ascends or descends vertically on the rack, to move to a target storage location for retrieving or storing a case. There is a risk of falling during an operation process of the transport robot on the rack. If the transport robot falls, the transport robot and goods carried by the transport robot may be damaged.

### SUMMARY OF THE INVENTION

In view of the foregoing problem, embodiments of this application provide an anti-falling apparatus, a transport robot, an anti-falling method and device, and a storage medium, to resolve a problem in the related art about how to stop a transport robot from falling after the transport robot falls during an operation process of the transport robot on a rack.

According to an aspect of the embodiments of this application, an anti-falling apparatus is provided, used in a transport robot, where the transport robot is capable of ascending or descending vertically along a rack rail on a rack, the transport robot includes a braking mechanism, and the anti-falling apparatus includes: an acceleration measurement unit, configured to measure an acceleration of the transport robot; and a control unit, configured to obtain the acceleration, the control unit is further configured to detect, according to the acceleration, whether the transport robot falls on the rack rail, and when detecting that the transport robot falls on the rack rail, control the braking mechanism to apply braking, to stop the transport robot from falling.

In an optional manner, the acceleration measurement unit is a three-axis acceleration sensor, and the acceleration includes an X-axis acceleration, a Y-axis acceleration, and a Z-axis acceleration; and the control unit is configured to: calculate a resultant acceleration amplitude according to the X-axis acceleration, the Y-axis acceleration, and the Z-axis acceleration, and detect, according to the resultant acceleration amplitude, whether the transport robot falls on the rack rail.

In an optional manner, the control unit is configured to determine that the transport robot falls on the rack rail when the resultant acceleration amplitude is less than a falling threshold, where the falling threshold is determined according to a difference between a gravitational acceleration value and a maximum descending acceleration value when the transport robot actively descends.

In an optional manner, the falling threshold is equal to the difference between the gravitational acceleration value and the maximum descending acceleration value minus an allowable tolerance value, where the allowable tolerance value is a preset value.

In an optional manner, the transport robot further includes a switch unit electrically connected to the braking mechanism; and the control unit is configured to be electrically connected to the switch unit; and the control unit is configured to send a control signal to the switch unit to control an action of the switch unit, so that the braking mechanism applies braking.

In an optional manner, the braking mechanism is a brake of a motor of the transport robot; and the control unit is configured to send the control signal to the switch unit to control the action of the switch unit, and the brake applies braking, so that the transport robot stops at a current position on the rack rail.

In an optional manner, holes are provided on the rack rail at intervals; and the control unit is configured to send the control signal to the switch unit to control the action of the switch unit, to cause a braking member of the braking mechanism to extend to be engaged in the holes, so that the transport robot stops at a current position on the rack rail.

In an optional manner, the braking mechanism is an electromagnetic lock of the transport robot, holes are provided on the rack rail at intervals, and that the control unit is configured to send the control signal to the switch unit to control the action of the switch unit, so that the braking mechanism applies braking includes: the control unit is configured to send the control signal to the switch unit, to control the switch unit to be turned off, and a lock bolt of the electromagnetic lock is engaged in the holes, so that the transport robot stops at the current position on the rack rail.

In an optional manner, the anti-falling apparatus further includes a signal converter and a power amplifier, where the signal converter is separately electrically connected to the control unit and the power amplifier, and the power amplifier is configured to be electrically connected to the switch unit, where that the control unit is configured to send the control signal to the switch unit, to control the switch unit to be turned off includes: the control unit is configured to output a digital control signal to the signal converter; the signal converter is configured to convert the digital control signal into an analog control signal and transmit the analog control signal to the power amplifier; and the power amplifier is configured to amplify the analog control signal and send the amplified analog control signal to the switch unit, to control the switch unit to be turned off.

In an optional manner, the transport robot further includes a master control unit, and the anti-falling apparatus further includes a communication transceiver configured to be communicatively connected to the master control unit, where the communication transceiver is configured to send a falling prompt message to the master control unit if the control unit detects that the transport robot falls on the rack rail.

According to another aspect of the embodiments of this application, a transport robot is provided, including the anti-falling apparatus according to any one of the foregoing.

According to another aspect of the embodiments of this application, an anti-falling method is provided, applied to a transport robot, where the transport robot is capable of ascending or descending vertically along a rack rail on a rack, the transport robot includes a braking mechanism, and the method includes: obtaining an acceleration of the transport robot; detecting, according to the acceleration, whether the transport robot falls on the rack rail; and controlling the braking mechanism to apply braking when detecting that the transport robot falls on the rack rail, to stop the transport robot from falling.

According to another aspect of the embodiments of this application, an anti-falling device is provided, including: a processor, a memory, a communication interface, and a communication bus, where the processor, the memory, and the communication interface complete mutual communication by using the communication bus; and the memory is configured to store executable instructions, where the executable instructions enable the processor to perform the operations of the anti-falling method according to the foregoing.

According to still another aspect of the embodiments of this application, a computer-readable storage medium is provided, where the storage medium stores at least one executable instruction, and when the at least one executable instruction is executed on an electronic device, the electronic device is caused to perform the operations of the anti-falling method according to the foregoing.

In the embodiments of this application, by arranging the anti-falling apparatus which includes the acceleration measurement unit and the control unit, the control unit obtains the acceleration of the transport robot by using the acceleration measurement unit, further detects, according to the obtained acceleration, whether the transport robot falls, and if the transport robot falls, controls, in time, the braking mechanism of the transport robot to apply braking, so that the transport robot stops falling, and stays at the current position on the rack rail, thereby preventing the transport robot from being damaged.

The foregoing descriptions are merely an overview of the technical solutions of the embodiments of this application. To understand the technical means of the embodiments of this application more clearly, implementation can be performed according to content of the specification. Moreover, to make the foregoing and other objectives, features, and advantages of the embodiments of this application more comprehensible, specific implementations of this application are listed below.

### BRIEF DESCRIPTION OF DRAWINGS

The accompanying drawings are merely used for illustrating the implementations and are not intended to constitute a limitation on this application. Throughout the accompanying drawings, the same reference numerals are used to represent the same components. In the accompanying drawings:

FIG. 1 is a schematic diagram of an application scenario according to an embodiment of this application;

FIG. 2 is a schematic diagram of composition of an anti-falling apparatus according to an embodiment of this application;

FIG. 3 is a schematic diagram of composition of another anti-falling apparatus according to an embodiment of this application;

FIG. 4 is a schematic diagram of specific composition of the anti-falling apparatus according to FIG. 3;

FIG. 5 is a partial schematic structural diagram of an electromagnetic lock and a rack rail according to an embodiment of this application;

FIG. 6 is a schematic diagram of composition of another anti-falling apparatus according to an embodiment of this application;

FIG. 7 is a schematic structural diagram of a transport robot according to an embodiment of this application;

FIG. 8 is a flowchart of an anti-falling method according to an embodiment of this application; and

FIG. 9 is a schematic structural diagram of an anti-falling device according to an embodiment of this application.

Reference numbers in the specific implementations are as follows:
10: Rack; 20: Case; 30: Rack rail;
40: Transport robot; 41: Braking mechanism; 42: Switch unit; 43: Power supply; 44: Master control unit;
100: Anti-falling apparatus; 101: Acceleration measurement unit; 102: Control unit; 103: Communication transceiver;
31: Hole; 411: Lock bolt;
402: Processor; 404: Communication interface; 406: Memory; 408: Communication bus; and 410: Program.

### DETAILED DESCRIPTION

The following describes in detail exemplary embodiments of this application with reference to the accompanying drawings. Although the accompanying drawings show the exemplary embodiments of this application, it should be understood that this application may be implemented in various manners and should not be limited by the embodiments described herein.

Unless otherwise defined, meanings of all technical and scientific terms used in this specification are the same as those usually understood by a person skilled in the art to which this application belongs. The terms used herein are merely for the purpose of describing specific embodiments, but are not intended to limit this application. The terms “include”, “have”, and any variant thereof in the specification and the claims of this application as well as the descriptions of the accompanying drawings are intended to cover non-exclusive inclusion.

In the descriptions of the embodiments of this application, the technical terms “first”, “second”, and the like are merely used to distinguish different objects, and should not be understood as indicating or implying relative importance, or implicitly indicating the number of indicated technical features, a specific order, or a primary-secondary relationship. In the descriptions of the embodiments of this application, unless otherwise specifically limited, “a plurality of” means at least two.

The term “embodiment” mentioned in the specification means that particular features, structures, or characteristics described with reference to the embodiment may be included in at least one embodiment of this application. The occurrence of the phrase at various positions in the specification does not necessarily refer to a same embodiment, nor is an independent or alternative embodiment mutually exclusive to other embodiments. A person skilled in the art explicitly or implicitly understands that the embodiments described in the specification may be combined with other embodiments.

In the descriptions of the embodiments of this application, the term “and/or” is merely an association relationship for describing associated objects, and indicates that three relationships may exist. For example, A and/or B may indicate the following three cases: Only A exists, both A and B exist, and only B exists. In addition, the character “/” in this specification usually indicates an “or” relationship between the associated objects.

In the descriptions of the embodiments of this application, the term “a plurality of” refers to at least two (including two). Similarly, “a plurality of groups” refers to at least two groups (including two groups), and “a plurality of pieces” refers to at least two pieces (including two pieces).

In the descriptions of the embodiments of this application, orientation or position relationships indicated by the technical terms such as “center”, “longitudinal”, “transverse”, “length”, “width”, “thickness”, “on”, “below”, “front”, “rear”, “left”, “right”, “vertical”, “horizontal”, “top”, “bottom”, “inside”, “outside”, “clockwise”, “anticlockwise”, “axial direction”, “radial direction”, and “circumferential direction” are based on orientation or position relationships shown in the accompanying drawings, and are used only for ease and brevity of illustration and description of the embodiments of this application, rather than indicating or implying that the mentioned apparatus or element must have a particular orientation or must be constructed and operated in a particular orientation. Therefore, such terms should not be construed as a limitation on the embodiments of this application.

In the descriptions of the embodiments of this application, unless otherwise explicitly specified or defined, the technical terms such as “install”, “connect”, “connection”, and “fix” should be understood in a broad sense. For example, the connection may be a fixed connection, a detachable connection, or an integral connection; or the connection may be a mechanical connection or an electrical connection; or the connection may be a direct connection, an indirect connection through an intermediate medium, internal communication between two elements, or an interaction relationship between two elements. A person of ordinary skill in the art may understand the specific meanings of the foregoing terms in the embodiments of this application according to specific situations.

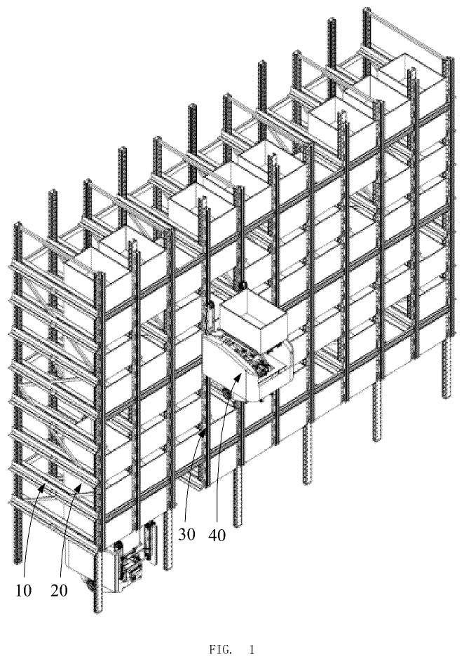

FIG. 1 is a schematic diagram of an application scenario according to an embodiment of this application. As shown in FIG. 1, in a warehousing system, a rack 10 includes 8 levels and 10 columns of storage locations, which are configured to store cases 20. At least in a vertical direction, rack rails 30 are arranged on the rack 10, so that a transport robot 40 may ascend and descend vertically along the rack rail 30 to reach different rack levels, thereby retrieving the cases 20 stored at the storage locations, or storing the cases 20 at the storage locations. Certainly, transverse rack rails may also be arranged on the rack 10 in a horizontal direction, so that the transport robot may move transversely along the transverse rack rails to reach different storage locations.

The inventor of this application understands that during an operation process of the transport robot 40 on the rack rail 30, for example, ascending or descending vertically and staying at a storage location to retrieve or store a case, if a component for ascending or descending in the transport robot 40 fails, or a controller for controlling the ascending of the transport robot 40 is abnormal or breaks down, leading to a failure of the transport robot 40 in controlling the transport robot to ascend or descend normally, or a failure in continuing to stop at a current stop position, the transport robot 40 is affected by factors such as gravity and inertia, and is prone to falling. As a result, the transport robot 40 and goods loaded on the transport robot are damaged, leading to a property loss and affecting normal operation of the warehousing system.

The inventor of this application notices that if the transport robot falls, a change amplitude of a descending speed of the transport robot is relatively large, that is, an acceleration is relatively large. Therefore, for the foregoing problems, this application provides an anti-falling apparatus, which detects whether the transport robot falls by detecting an acceleration of the transport robot, and controls, in time, a braking mechanism of the transport robot to apply braking when detecting that the transport robot falls, to stop the transport robot from falling, thereby preventing the transport robot from being damaged.

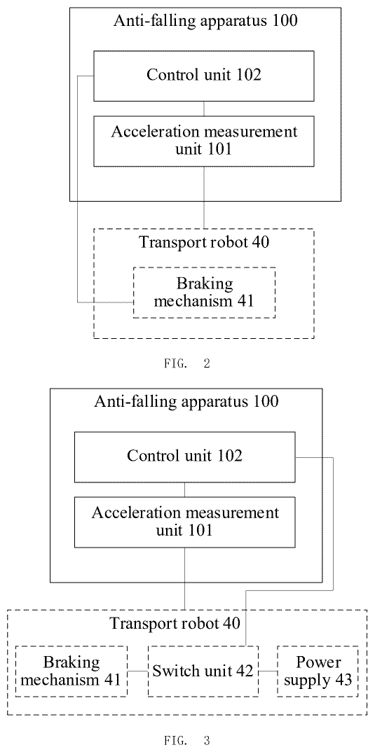

FIG. 2 is a schematic diagram of composition of an anti-falling apparatus according to an embodiment of this application. The anti-falling apparatus is used in a transport robot 40 including a braking mechanism 41. As shown in FIG. 2, the anti-falling apparatus 100 includes an acceleration measurement unit 101 and a control unit 102, where the acceleration measurement unit 101 is configured to measure an acceleration of the transport robot 40; and the control unit 102 is configured to: obtain the acceleration, detect, according to the acceleration, whether the transport robot 40 falls on a rack rail 30, and if detecting that the transport robot 40 falls on the rack rail 30, control the braking mechanism 41 to apply braking, to stop the transport robot 40 from falling.

The braking mechanism 41 of the transport robot 40 refers to an apparatus which is configured to control the transport robot 40 to stop. When the transport robot 40 moves, if the braking mechanism 41 applies braking, the transport robot 40 may be caused to stop moving. For example, the braking mechanism 41 may be a brake of a motor of the transport robot 40, or may be an electromagnetic lock of the transport robot 40.

The acceleration measurement unit 101 refers to a measurement unit for measuring the acceleration of the transport robot 40. In consideration of an impact of gravity and inertia, to ensure that the transport robot 40 can steadily ascend or descend vertically along the rack rail 30, the transport robot 40 is usually set to ascend or descend at a constant speed or with a slow acceleration, to prevent the transport robot 40 from being uncontrolled or being collided due to an excessively high ascending or descending speed or a large speed change amplitude. In other words, generally, the transport robot 40 actively ascends or descends at a constant speed or with a slow acceleration. If the transport robot 40 is abnormal, for example, the transport robot 40 fails to normally control the ascending or descending of the transport robot 40, or fails to continue to stop at a current stop position due to a failure of an ascending component, or abnormality or shutdown of a controller, a moving speed of the transport robot 40 may change greatly due to an impact of factors such as gravity and inertia, that is, the acceleration is relatively large, leading to falling of the transport robot 40. Therefore, it can be detected, according to the acceleration, whether the transport robot 40 falls by measuring the acceleration of the transport robot 40 by using the acceleration measurement unit 101. When the transport robot 40 falls, a speed in a vertical direction (that is, a Z-axis direction) of the transport robot 40 changes to some extent. Therefore, the acceleration measurement unit 101 may be a single-axis acceleration sensor and is configured to measure a Z-axis acceleration of the transport robot 40, to detect whether the transport robot 40 falls. The acceleration measurement unit 101 may alternatively be a sensor that can detect the Z-axis acceleration and another axial acceleration or another motion parameter, provided that parameters detected by the sensor includes the Z-axis acceleration.

The control unit 102 may be a single-chip microcontroller Unit (Microcontroller Unit, MCU), a system on chip (System on Chip, SOC), an application-specific integrated circuit (Application-Specific Integrated Circuit, ASIC), or one or more integrated circuits configured to implement the embodiments of this application, which is not limited herein.

Specifically, the acceleration measurement unit 101 is arranged on the transport robot 40, to measure the acceleration of the transport robot 40. The control unit 102 is configured to be separately electrically connected to the acceleration measurement unit 101 and the braking mechanism of the transport robot 40. When the transport robot 40 is located on the rack rail 30, the control unit 102 obtains the acceleration of the transport robot 40 in real time through the acceleration measurement unit 101, and further detects, according to the obtained acceleration, whether the transport robot 40 falls currently. For example, the control unit 102 may compare the obtained acceleration with a preset threshold. If the acceleration is greater than or equal to the preset threshold, that is, when a speed change amplitude of the transport robot 40 reaches a certain degree, the control unit 102 may determine that the transport robot 40 falls. If the control unit 102 detects that the transport robot 40 falls, the braking mechanism 41 is controlled to apply braking, so that the transport robot 40 stops falling and stays at a current position on the rack rail 30. For example, when detecting that the transport robot 40 falls, the control unit 102 sends a control signal to the braking mechanism 41, to control the braking mechanism 41 to apply braking in time.

In this embodiment of this application, through arrangement of the acceleration measurement unit 101 and the control unit 102, the control unit 102 obtains the acceleration of the transport robot 40 by using the acceleration measurement unit 101, further detects, according to the obtained acceleration, whether the transport robot 40 falls, and if the transport robot falls, controls, in time, the braking mechanism 41 of the transport robot 40 to apply braking, so that the transport robot 40 stops falling, and stays at the current position on the rack rail 30, thereby preventing the transport robot 40 from being damaged. To improve accuracy of determining whether the transport robot 40 falls, in this embodiment of this application, the acceleration measurement unit 101 is a three-axis acceleration sensor, and the acceleration measured by the three-axis acceleration sensor includes an X-axis acceleration, a Y-axis acceleration, and a Z-axis acceleration; and the control unit 102 is configured to: calculate a resultant acceleration amplitude according to the X-axis acceleration, the Y-axis acceleration, and the Z-axis acceleration, and detect, according to the resultant acceleration amplitude, whether the transport robot 40 falls on the rack rail 30. A three-axis acceleration sensor is selected, and a specific fixed posture of the sensor may not be limited.

Specifically, the three-axis acceleration sensor may detect the X-axis acceleration, the Y-axis acceleration, and the Z-axis acceleration of the transport robot 40. Therefore, after obtaining the X-axis acceleration, the Y-axis acceleration, and the Z-axis acceleration of the transport robot 40 through the three-axis acceleration sensor, the control unit 102 calculates the resultant acceleration amplitude according to the obtained accelerations, and may further detect, according to the resultant acceleration amplitude, whether the transport robot 40 falls. According to the following Formula 1, the resultant acceleration amplitude may be calculated based on the X-axis acceleration, the Y-axis acceleration, and the Z-axis acceleration:

$${G}_{i} = \sqrt{{X}_{i}^{2} + {Y}_{i}^{2} + {Z}_{i}^{2}} , \qquad Formula 1$$

Gᵢ is the resultant acceleration amplitude, Xᵢ is the X-axis acceleration, Y, is the Y-axis acceleration, and Zᵢ is the Z-axis acceleration.

When the transport robot 40 falls, the acceleration of the transport robot 40 is not limited to a single direction, that is, the acceleration changes in three orthogonal directions (that is, an X-axis direction, a Y-axis direction, and a Z-axis direction). Therefore, in this embodiment of this application, the control unit 102 simultaneously measures the accelerations of the transport robot 40 in the three orthogonal directions through the three-axis acceleration sensor, and calculates the resultant acceleration amplitude according to the obtained accelerations in the three orthogonal directions, to more comprehensively and accurately determine whether the transport robot 40 falls. When accurately determining that the transport robot 40 falls, the control unit may control, in time, the braking mechanism 41 to apply braking, so that the transport robot 40 stops falling, thereby effectively preventing the transport robot 40 from being damaged.

In some embodiments, to obtain an acceleration with relatively high accuracy, the anti-falling apparatus 100 further includes a sliding filter configured to perform data processing on the acceleration of the transport robot 40 measured by the acceleration measurement unit 101, to reduce an impact of measurement signal noise, and obtain the acceleration with relatively high accuracy, thereby improving the accuracy of determining whether the transport robot 40 falls.

To improve the accuracy of the control unit 102 in determining, according to the acceleration of the transport robot 40, whether the transport robot 40 falls, in this embodiment of this application, an acceleration threshold, that is, a falling threshold configured for determining whether the transport robot falls is first set, and the threshold is determined according to a difference between a gravitational acceleration value and a maximum descending acceleration value when the transport robot 40 actively descends. The control unit 102 is configured to determine that the transport robot 40 falls on the rack rail 30 if the resultant acceleration amplitude is less than the falling threshold.

The maximum descending acceleration when the transport robot 40 actively descends refers to a maximum acceleration that can be reached when the transport robot 40 descends along the rack rail 30 in a normal operating state. The falling threshold may be the difference between the gravitational acceleration value and the maximum descending acceleration value when the transport robot 40 actively descends.

The gravitational acceleration is 1.0 g (generally, g is 9.8 m/s²), and a direction is a vertically downward direction. To overcome the gravitational acceleration, the transport robot 40 can be static on the rack rail 30 only when being subjected to a vertically upward acceleration of 1.0 g. That is, when the transport robot 40 is static on the rack rail 30, the acceleration of the transport robot 40 measured by the acceleration measurement unit 101 is 1.0 g (unless otherwise specified, in this embodiment of this application, a direction of the acceleration of the transport robot 40 measured by the acceleration measurement unit 101 is a vertically upward direction).

Only when the transport robot 40 is subjected to an acceleration greater than 1.0 g in the vertically upward direction, the transport robot can ascend along the rack rail 30 with an acceleration. That is, when the transport robot 40 ascends along the rack rail 30 with an acceleration, the acceleration value of the transport robot 40 that is measured by the acceleration measurement unit 101 is greater than 1.0 g.

When the transport robot 40 vertically descends along the rack rail 30, to prevent the transport robot 40 from being out of control due to an excessively high descending speed, in combination with the gravitational acceleration, the maximum descending acceleration value of the transport robot 40 when the transport robot actively descends may be set to b g. Therefore, when the transport robot 40 is subjected to an acceleration that is not less than (1.0-b) g in the vertically upward direction, the descending acceleration value when the transport robot actively descends can be controlled to be within a range not exceeding b g. The foregoing falling threshold may be set to a minimum value a g of the acceleration. That is, when the transport robot 40 is in a normal operation state and actively descends on the rack rail 30, the acceleration value of the transport robot 40 measured by the acceleration measurement unit 101 should be greater than or equal to a g. If the acceleration value of the transport robot 40 measured by the acceleration measurement unit 101 is less than a g when the transport robot 40 descends, it indicates that the descending acceleration value of the transport robot is greater than (1.0-a) g currently, that is, greater than the maximum descending acceleration value b g when the transport robot actively descends. Therefore, it may be determined that the transport robot 40 is in an abnormal state in which the transport robot 40 falls.

For example, if the maximum descending acceleration value when the transport robot 40 actively descends is set to 0.5 g, when the transport robot 40 actively descends along the rack rail 30, the acceleration value of the transport robot 40 measured by the acceleration measurement unit 101 should be greater than or equal to (1-0.5) g, that is, 0.5 g. If the acceleration value of the transport robot 40 measured by the acceleration measurement unit 101 is 0.2 g (less than 0.5 g), it indicates that a descending acceleration value of the transport robot 40 is 0.8 g, that is, greater than the maximum descending acceleration value 0.5 g when the transport robot actively descends. Therefore, it is determined that the transport robot 40 falls currently.

In this embodiment of this application, the falling threshold is determined according to the difference between the gravitational acceleration value and the maximum descending acceleration value when the transport robot 40 actively descends, so that the control unit 102 may quickly and effectively determine, according to a magnitude relationship between the acceleration value of the transport robot 40 and the falling threshold, whether the transport robot 40 falls.

To further improve the accuracy of the control unit 102 in determining, according to the acceleration of the transport robot 40, whether the transport robot 40 falls, in this embodiment of this application, the falling threshold is equal to the difference between the gravitational acceleration value and the maximum descending acceleration value minus an allowable tolerance value, where the allowable tolerance value is a preset value.

It is assumed that the maximum descending acceleration value when the transport robot 40 actively descends is b g, and the falling threshold a=(1.0-b) g is set. However, because a specific error exists during operation of the transport robot 40, the maximum descending acceleration value when the transport robot actively descends fluctuates, that is, fluctuates around b g. However, a fluctuation range is usually small. When the transport robot 40 actively descends, if the maximum descending acceleration value when the transport robot actively descends is slightly greater than b g due to an operation error of the transport robot, correspondingly, the acceleration value of the transport robot 40 measured by the acceleration measurement unit 101 is less than (1.0-b) g, that is, less than a g. In this case, if it is directly determined that the transport robot 40 falls, a misjudgment may be caused.

Therefore, in this embodiment of this application, the falling threshold is determined as the difference between the gravitational acceleration value and the maximum descending acceleration value minus the allowable tolerance value, so that when the maximum descending acceleration value when the transport robot 40 actively descends is greater than the set value due to the operation error, a misjudgment that the transport robot 40 falls can be avoided, thereby increasing the accuracy of determining whether the transport robot 40 falls. In addition, when the transport robot 40 falls, the descending acceleration value of the transport robot is relatively large, that is, much greater than b g. Therefore, in this embodiment of this application, the falling threshold is set to the difference between the gravitational acceleration value and the maximum descending acceleration value minus the allowable tolerance value, so that a case in which falling of the transport robot 40 fails to be recognized does not occur. The allowable tolerance value may be preset according to an actual situation, and may usually range from 0.05 g to 0.25 g. For example, the allowable tolerance value is set to 0.2 g. If the maximum descending acceleration value when the transport robot 40 actively descends is 0.5 g, the falling threshold may be set to 1.0 g-0.5 g-0.2 g=0.3 g.

In some embodiments, as shown in FIG. 7, the transport robot 40 includes the anti-falling apparatus 100. The control unit 102 of the anti-falling apparatus 100 and a master control unit of the transport robot 40 may be a same control unit, or may be different control units. When the two control units are not the same control unit, the two control units may communicate with each other in a wired or wireless manner. After receiving a signal that is sent by the control unit 102 of the anti-falling apparatus 100 and that indicates that the transport robot 40 falls, the master control unit of the transport robot 40 controls the braking mechanism 41 of the transport robot to apply braking.

To enable the control unit 102 to effectively control the braking mechanism to apply braking, based on the anti-falling apparatus provided in FIG. 2, FIG. 3 is a schematic diagram of composition of another anti-falling apparatus according to an embodiment of this application. As shown in FIG. 3, the anti-falling apparatus 100 includes an acceleration measurement unit 101 and a control unit 102. The transport robot 40 further includes a switch unit 42 and a power supply 43, where one end of the switch unit 42 is electrically connected to the braking mechanism 41, the other end is electrically connected to the power supply 43, and the control unit 102 is configured to electrically connected to the switch unit 42. When the control unit 102 detects that the transport robot 40 falls, the control unit 102 is configured to send a control signal to the switch unit 42, to control an action of the switch unit 42, so that the braking mechanism 41 applies braking.

When the switch unit 42 is turned on, the braking mechanism 41 is connected to the power supply 43 through the switch unit 42, so that the braking mechanism 41 is in a non-braking state, that is, the transport robot 40 can normally ascend or descend vertically along the rack rail 30. If the switch unit 42 is turned off, the braking mechanism 41 cannot be connected to the power supply through the switch unit 42 to apply braking. Certainly, the foregoing control logic may alternatively be that the braking mechanism 41 is in the non-braking state when the switch unit is turned off, and the braking mechanism 41 applies braking when the switch unit is turned off.

If the braking mechanism 41 applies braking in a power-off state, and does not apply braking in a power-on state, in this embodiment of this application, when detecting that the transport robot 40 falls, the control unit 102 sends the control signal to the switch unit 42 in time, to control the action of the switch unit 42, that is, control the switch unit 42 to be turned off, thereby effectively controlling the braking mechanism 41 to apply braking in time. In addition, the switch unit 42 is controlled to be turned off through the control signal, so that the braking mechanism 41 applies braking. The control manner is simple and efficient. Therefore, when it is detected that the transport robot 40 falls, the braking mechanism 41 can be controlled in time to apply braking, thereby effectively preventing the transport robot 40 from being damaged. It is similar for a case in which the control logic is that the braking mechanism 41 is in the non-braking state when the switch unit is turned off, and the braking mechanism 41 applies braking when the switch unit is turned on.

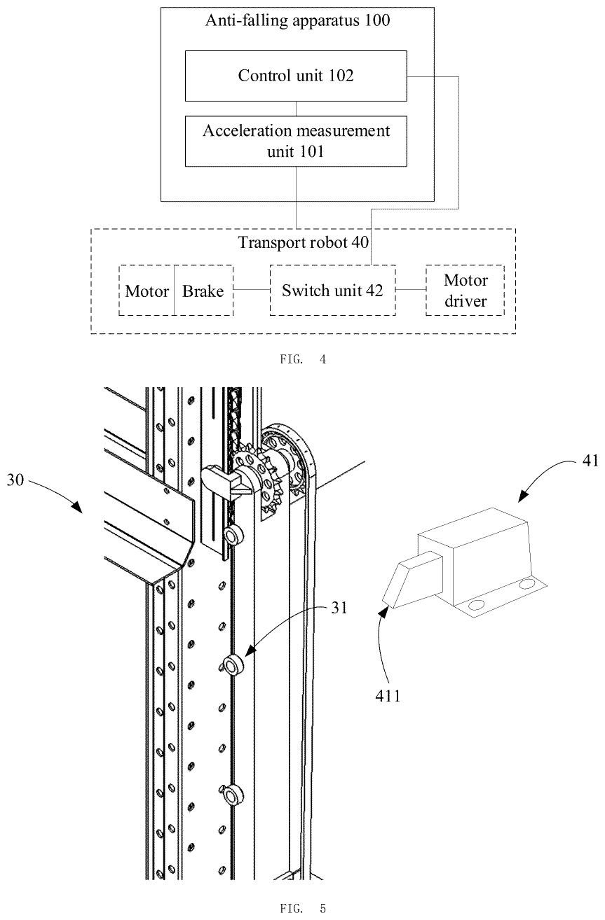

To further enable the control unit 102 to effectively control the braking mechanism to apply braking, based on the anti-falling apparatus provided in FIG. 3, FIG. 4 is a schematic diagram of specific composition of the anti-falling apparatus according to FIG. 3. As shown in FIG. 4, the anti-falling apparatus 100 includes an acceleration measurement unit 101 and a control unit 102. The transport robot 40 includes a motor driver for providing power to a motor. The braking mechanism is a brake of the motor of the transport robot 40, and the motor driver also provides power to the brake of the motor. When the control unit 102 detects that the transport robot 40 falls, the control unit 102 is configured to send a control signal to the switch unit 42, to control the switch unit 42 to be turned off, and the brake applies braking, so that the transport robot 40 stops at a current position on the rack rail 30.

One end of the switch unit 42 is electrically connected to the motor, and the other end is electrically connected to the motor driver. When the switch unit is turned on, the motor driver is configured to provide power to the motor and the brake through the switch unit, so that the transport robot 40 can ascend or descend vertically along the rack rail 30, and the brake is in a non-braking state.

Specifically, the brake of the motor may be an electromagnetic brake. If the motor is connected to the power through the switch unit, a coil of the electromagnetic brake obtains the power, and the brake is in the non-braking state. If the switch unit is turned off, the motor cannot be connected to the power through the switch unit, the coil of the electromagnetic brake is powered off, and the electromagnetic brake applies braking, to provide a torque opposite to a rotation direction to the motor, so as to cause the motor to quickly stop rotation. Alternatively, the brake includes a braking electromagnet and a brake-shoe brake. The braking electromagnet includes three parts, namely, an iron core, an armature, and a coil. The brake-shoe brake includes a brake pulley, a brake shoe, a spring, and the like. The brake pulley and the motor are installed on a same rotation shaft. When the switch unit is turned on, the motor is connected to the power, the coil of the electromagnetic brake is also powered on, the armature is attracted and overcomes tension of the spring to separate the brake shoe from the brake pulley of the brake, and the motor operates normally. If the switch unit is turned off, the motor is powered off, and the coil of the electromagnetic brake is also powered off, the armature is separated from the iron core under the action of the tension of the spring, the brake shoe of the brake tightly holds the brake pulley, and the motor is braked and stops rotation.

In this embodiment of this application, by using the brake of the motor of the transport robot 40, if the control unit 102 detects that the transport robot 40 falls, the switch unit is controlled to be turned off, and the brake is powered off and further applies braking, so that the transport robot 40 stops at the current position on the rack rail 30.

In some embodiments, holes are provided on the rack rail 30 at intervals, the control unit 102 is configured to send a control signal to the switch unit 42 to control the action of the switch unit 42, and a braking member of the braking mechanism 41 extends to be engaged in the holes on the rack rail 30, so that the transport robot 40 stops at the current position on the rack.

The braking mechanism 41 includes the braking member, and when the braking mechanism is in a non-braking state, the braking member is in a contracted state. The braking member of the braking mechanism 41 is controlled to extend to be engaged in the holes, so that the braking mechanism 41 applies braking. The braking mechanism 41 may be a powered-on braking mechanism. If the braking mechanism 41 is in the non-braking state when being powered on, and applies braking when being powered off, in this embodiment of this application, the braking mechanism 41 is connected to the power through the switch unit 42, and sends a control signal to the switch unit 42 through the control unit 102, so that the switch unit 42 is turned off, and the braking mechanism applies braking.

Based on the foregoing embodiments, in this embodiment of this application, the braking mechanism may be an electromagnetic lock of the transport robot 40. To better describe the rack rail and the electromagnetic lock herein, FIG. 5 is a partial schematic structural diagram of an electromagnetic lock and a rack rail according to an embodiment of this application (other structures of the transport robot are not shown in the figure, and only the electromagnetic lock is shown). As shown in FIG. 5, holes 31 are provided on the rack rail 30 at intervals, the braking mechanism 41 of the transport robot 40 is an electromagnetic lock, and the electromagnetic lock includes a lock bolt 411. When the control unit 102 detects that the transport robot 40 falls, the control unit 102 is configured to send a control signal to the switch unit 42, to control the switch unit 42 to be turned off, and the lock bolt 411 of the electromagnetic lock is engaged in the holes 31, so that the transport robot stops at the current position on the rack rail 30.

The holes 31 may be blind holes or through holes, and sizes of the holes match a size of the lock bolt 411, so that the lock bolt 411 can be engaged in the holes 31. The electromagnetic lock further includes a spring, an electromagnetic coil, and a lock body. The lock bolt 411 and the lock body are connected through the spring. When the switch unit is turned on, the electromagnetic lock is powered on, that is, the electromagnetic coil is powered on. A current flows through the electromagnetic coil to generate a magnetic field, so that the lock bolt 411 is attracted to lock with the lock body, and the spring is in a contracted state. If the switch unit is turned off, the electromagnetic lock is powered off, that is, the electromagnetic coil is powered off, the magnetic field disappears, and the lock bolt 411 cannot be attracted to lock with the lock body, so that the spring stretches and pops up the lock bolt 411 in a direction away from the lock body.

Therefore, in this embodiment of this application, because the braking mechanism 41 is the electromagnetic lock of the transport robot 40, when the control unit 102 detects that the transport robot 40 falls, the lock bolt 411 of the electromagnetic lock is controlled to pop up, so that when the transport robot 40 falls, the lock bolt 411 may be engaged in the holes 31, to cause the transport robot 40 to stop at the current position on the rack rail.

It may be understood that, when the transport robot 40 falls, after the lock bolt 411 is popped up, if the lock bolt 411 cannot be engaged in the holes 31 due to another reason, for example, a relatively high falling speed of the transport robot 40, friction also occurs between the lock bolt 411 and the holes 31 when the transport robot 40 falls, so that the falling speed of the transport robot 40 may also be reduced, thereby preventing the transport robot 40 from being damaged or reducing a damage degree of the transport robot.

To further enable the control unit 102 to effectively control the braking mechanism to apply braking, based on the embodiment provided in FIG. 3, in this embodiment of this application, the anti-falling apparatus 100 further includes a signal converter and a power amplifier. The signal converter is separately electrically connected to the control unit 102 and the power amplifier. The power amplifier is configured to be electrically connected to the switch unit.

The control unit 102 is configured to output a digital control signal to the signal converter.

The signal converter is configured to convert the digital control signal into an analog control signal and transmit the analog control signal to the power amplifier.

The power amplifier is configured to amplify the analog control signal and send the amplified analog control signal to the switch unit, to control the switch unit to be turned off.

Because the digital control signal outputted by the control unit 102 cannot directly control the switch unit to be turned off, in this embodiment of this application, the digital control signal outputted by the control unit 102 is converted into the analog control signal through the signal converter, that is, the switch unit may be controlled through the analog control signal to be turned off. In addition, because the amplified analog control signal can drive a relatively large load, in this embodiment of this application, the power amplifier is used to amplify the analog control signal, so that the amplified analog control signal may be used to effectively control the switch unit to be turned off, thereby avoiding a case in which the analog control signal cannot drive the switch unit to be turned off, and ensuring that when it is detected that the transport robot 40 falls, the braking mechanism may be effectively controlled to apply braking, to cause the transport robot 40 to stop falling. The signal converter may be a PDO (Powered Digital Output), and the power amplifier may be a transistor, a field effect transistor, a Darlington transistor, or the like.

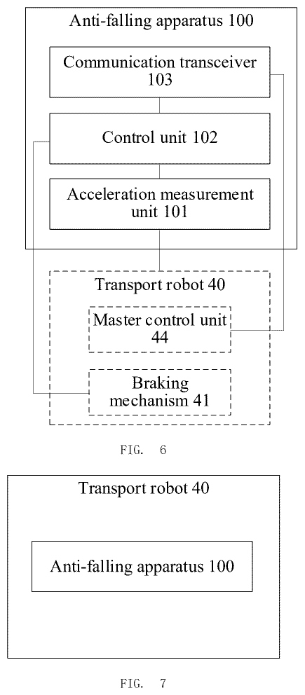

When the transport robot falls, to enable the transport robot to prompt a user, so as to enable the user to perform abnormality processing in time, in this embodiment of this application, based on the anti-falling apparatus provided in FIG. 2, FIG. 6 is a schematic diagram of composition of another anti-falling apparatus according to an embodiment of this application. As shown in FIG. 6, the transport robot 40 further includes a master control unit 44. The anti-falling apparatus 100 further includes a communication transceiver 103 configured to be communicatively connected to the master control unit 44, where the communication transceiver 103 is configured to send a falling prompt message to the master control unit 44 if the control unit 102 detects that the transport robot 40 falls on the rack rail 30. The communication transceiver 103 may be a CAN transceiver, and is hung to a CAN interface of an MCU to implement a CAN communication function.

In this embodiment of this application, the falling prompt message is configured for prompting the user that the transport robot 40 falls currently, so that the user performs abnormality processing in time, thereby avoiding a property loss.

FIG. 7 is a schematic structural diagram of a transport robot according to an embodiment of this application. As shown in FIG. 7, the transport robot 40 includes an anti-falling apparatus 100.

An implementation principle and technical effects of the anti-falling apparatus 100 included in the transport robot 40 provided in this embodiment are similar to those of the anti-falling apparatus 100 in any one of the foregoing apparatus embodiments, and details are not described herein.

In some embodiments, if the transport robot 40 is suddenly powered off, the braking mechanism of the transport robot autonomously applies braking, to avoid that the transport robot 40 falls when the transport robot is in an uncontrolled state due to the power-off.

In some embodiments, the transport robot 40 further includes components that cooperate with the anti-falling apparatus 100 in the foregoing embodiments, for example, one or more of components such as a braking mechanism, a switch unit, a power supply, a motor, a motor driver, and an electromagnetic lock, to operate together to implement anti-falling for the transport robot 40.

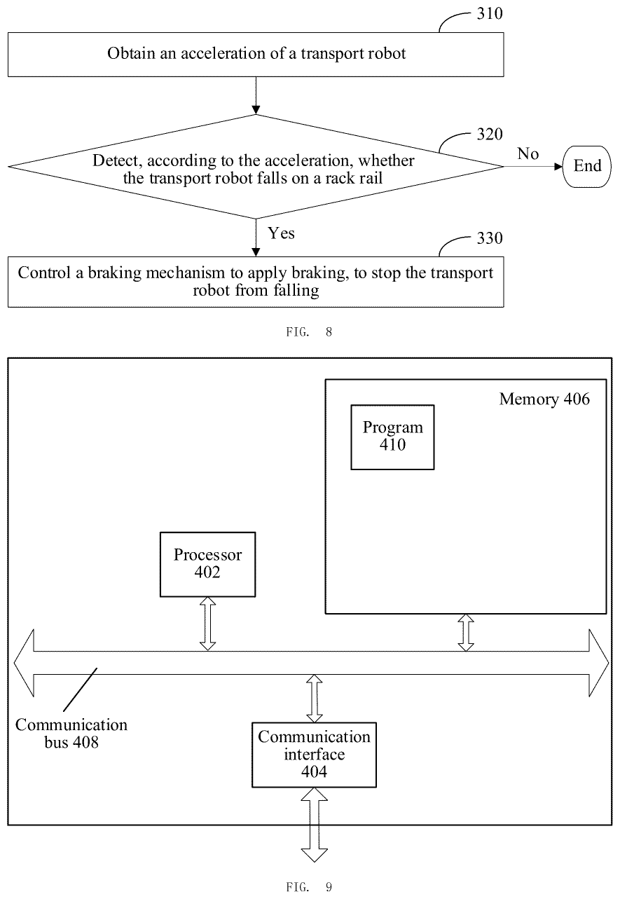

FIG. 8 is a flowchart of an anti-falling method according to an embodiment of this application. The method is performed by a single-chip microcontroller unit (Microcontroller Unit, MCU), an application-specific integrated circuit (Application-Specific Integrated Circuit, ASIC), or one or more integrated circuits configured to implement the embodiments of this application, which is not limited herein. The method is applied to a transport robot 40 which includes a braking mechanism. As shown in FIG. 8, the method includes the following operations:

At block 310: obtaining an acceleration of the transport robot.

At block 320: detecting, according to the acceleration, whether the transport robot falls on a rack rail. If the transport robot falls on the rack rail, operation of block 330 is performed; or if the transport robot does not fall on the rack rail, the procedure ends.

At block 330: controlling the braking mechanism to apply braking, to stop the transport robot from falling.

An implementation principle and technical effects of the anti-falling method provided in this embodiment of this application are similar to those of the anti-falling apparatus 100 in the embodiment provided in FIG. 2, and details are not described herein again.

To improve accuracy of determining whether the transport robot falls, in this embodiment of this application, the acceleration includes an X-axis acceleration, a Y-axis acceleration, and a Z-axis acceleration, and step 320 includes:

Operation a: calculating a resultant acceleration amplitude according to the X-axis acceleration, the Y-axis acceleration, and the Z-axis acceleration, and detecting, according to the resultant acceleration amplitude, whether transport robot falls on the rack rail.

In this embodiment of this application, accelerations of the transport robot in three orthogonal directions are measured, and the resultant acceleration amplitude is calculated according to the obtained accelerations in the three orthogonal directions, so that whether transport robot falls may be determined more comprehensively and accurately.

In some embodiments, operation a includes:

Operation a1: determining whether the resultant acceleration amplitude is less than a falling threshold, where the falling threshold is determined according to a difference between a gravitational acceleration value and a maximum descending acceleration value when the transport robot actively descends. If the resultant acceleration amplitude is less than the falling threshold, operation a2 is performed; or if the resultant acceleration amplitude is not less than the falling threshold, the procedure ends.

Operation a2: determining that the transport robot falls on the rack rail.

In this embodiment of this application, the falling threshold is determined according to the difference between the gravitational acceleration value and the maximum descending acceleration value when the transport robot actively descends, so that whether the transport robot falls may be quickly and effectively determined according to a magnitude relationship between the acceleration value of the transport robot and the falling threshold.

In some embodiments, the falling threshold is equal to the difference between the gravitational acceleration value and the maximum descending acceleration value minus an allowable tolerance value.

In this embodiment of this application, the falling threshold is determined as the difference between the gravitational acceleration value and the maximum descending acceleration value minus the allowable tolerance value, so that when the maximum descending acceleration value is greater than a set value due to an operation error when the transport robot actively descends, a misjudging that the transport robot falls can be avoided, thereby improving the accuracy of determining whether the transport robot falls.

In some embodiments, the transport robot further includes a switch unit electrically connected to the braking mechanism, and the control unit is configured to be electrically connected to the switch unit. Operation 330 includes: sending a control signal to the switch unit to control the switch unit to be turned off, to cause the braking mechanism to apply braking.

In this embodiment of this application, when it is detected that the transport robot falls, the control signal is sent to the switch unit in time, to control the switch unit to be turned off, thereby effectively controlling the braking mechanism to apply braking in time.

In some embodiments, the braking mechanism is a brake of a motor of the transport robot. The sending the control signal to the switch unit to control the switch unit to be turned off, to cause the braking mechanism to apply braking includes:
sending the control signal to the switch unit to control the switch unit to be turned off, to cause the brake to apply braking, so as to cause the transport robot to stop at a current position on the rack rail.

In this embodiment of this application, if it is detected that the transport robot falls, the switch unit is controlled to be turned off, and the brake is powered off to apply braking, so that the transport robot stops at the current position on the rack rail.

In some embodiments, the braking mechanism is an electromagnetic lock of the transport robot, and holes are provided on the rack rail at intervals. The sending the control signal to the switch unit to control the switch unit to be turned off, to cause the braking mechanism to apply braking includes: sending the control signal to the switch unit, to control the switch unit to be turned off, to cause a lock bolt of the electromagnetic lock to be engaged in the holes, so as to cause the transport robot to stop at a current position on the rack rail.

In this embodiment of this application, because the braking mechanism is the electromagnetic lock of the transport robot, when it is detected that the transport robot falls, the lock bolt of the electromagnetic lock is controlled to pop up, and when the transport robot falls, the lock bolt may be engaged in the holes, so that the transport robot stops at the current position on the rack rail.

In some embodiments, the anti-falling apparatus further includes a signal converter and a power amplifier, where the signal converter is separately electrically connected to the control unit and the power amplifier, and the power amplifier is configured to be electrically connected to the switch unit. The sending the control signal to the switch unit to control the switch unit to be turned off includes: outputting a digital control signal to the signal converter, so that the signal converter converts the digital control signal into an analog control signal and transmits the analog control signal to the power amplifier, and the power amplifier amplifies the analog control signal and sends the amplified analog control signal to the switch unit, to control the switch unit to be turned off.

In this embodiment of this application, the digital control signal is outputted to the signal converter, so that the signal converter converts the digital control signal into the analog control signal, that is, the switch unit may be controlled to be turned off through the analog control signal. In addition, because the amplified analog control signal can drive a relatively large load, in this embodiment of this application, after the power amplifier amplifiers the analog control signal, it is ensured that the amplified analog control signal can effectively control the switch unit to be turned off, thereby avoiding a case in which the analog control signal cannot drive the switch unit to be turned off.

FIG. 9 is a schematic structural diagram of an anti-falling device according to an embodiment of this application. A specific implementation of the anti-falling device is not limited in specific embodiments of this application.

As shown in FIG. 9, the anti-falling device may include a processor (processor) 402, a communication interface (communication Interface) 404, a memory (memory) 406, and a communication bus 408.

The processor 402, the communication interface 404, and the memory 406 complete mutual communication by using the communication bus 408. The communication interface 404 is configured for communication with another device, for example, a client or a network element of another server. The processor 402 is configured to execute a program 410, and may specifically perform the related steps in the foregoing embodiments of the anti-falling method.

Specifically, the program 410 may include program code, and the program code includes computer-executable instructions.

The processor 402 may be a central processing unit (CPU), an application-specific integrated circuit (Application-Specific Integrated Circuit), or one or more integrated circuits configured to implement the embodiments of this application. One or more processors included in the anti-falling device may be processors of a same type such as one or more CPUs, or may be processors of different types such as one or more CPUs and one or more ASICs.

The memory 406 is configured to store the program 410. The memory 406 may include a high-speed RAM memory, or may further includes a non-volatile memory (non-volatile memory), for example, at least one magnetic disk memory.

An embodiment of this application provides a computer-readable storage medium, having executable instructions stored herein, where when the executable instructions are executed an anti-falling device, the anti-falling device is caused to perform the anti-falling method in any one of the method embodiments.

An embodiment of this application provides a computer program, where the computer program may be invoked by a processor to cause an anti-falling device to perform the anti-falling method in any one of the method embodiments.

An embodiment of this application provides a computer program product, where the computer program product includes a computer program stored in a computer-readable storage medium, and the computer program includes program instructions. When the program instructions are executed on a computer, the computer is caused to perform the anti-falling method in any one of the method embodiments.

The algorithms or displays provided herein are not inherently related to any particular computer, virtual system, or other devices. Various general-purpose systems can also be used together with teaching set forth herein. From the above descriptions, a structure required to construct such a system is evidently clear. In addition, the embodiments of this application are not directed to any particular programming language. It should be understood that the content of this application described herein may be implemented by using various programming languages and the above descriptions of a particular language are to disclose an optimal implementation of this application.

In the specification provided herein, numerous specific details are described. However, it can be understood that, the embodiments of this application may be practiced without the specific details. In some examples, well-known methods, structures, and technologies are not shown in detail, so as not to obscure understanding of this specification.

Similarly, it should be understood that to simplify this application and help to understand one or more of disclosure aspects, in the descriptions of the exemplary embodiments of this application, features of the embodiments of this application are sometimes grouped into a single embodiment or figure, or descriptions thereof. However, the disclosed method should not be construed as reflecting the following intention: that is, this application claimed to be protected is required to have more features than those clearly set forth in each claim.

A person skilled in the art may understand that, modules in a device in an embodiment may be adaptively changed and disposed in one or more devices different from the embodiment. The modules or units or components in the embodiment may be combined into one module or unit or component, and may each be divided into a plurality of sub-modules or sub-units or sub-components. Except for the cases that at least some of such features and/or processes or units are mutually exclusive, all features disclosed in this specification (including the appended claims, abstract, and accompanying drawings) and all processes or units of any method or device so disclosed may be combined in any form. Unless otherwise expressly stated, each feature disclosed in this specification (including the appended claims, abstract, and accompanying drawings) may be replaced with an alternative feature that achieves the same, equivalent, or similar purpose.

It should be noted that the above-mentioned embodiments illustrate rather than limit this application, and a person skilled in the art may devise alternative embodiments without departing from the scope of the appended claims. In the claims, any reference sign between parentheses shall not be construed as a limitation on the claims. The word “comprise” does not exclude the presence of elements or steps not listed in the claims. The word “a” or “an” preceding an element does not exclude the presence of a plurality of such elements. This application can be implemented by way of hardware including several different elements and an appropriately programmed computer. In the unit claims enumerating several apparatuses, several of these apparatuses can be specifically embodied by the same item of hardware. The use of the words such as “first”, “second”, “third”, and the like does not denote any order. These words can be interpreted as names. Unless otherwise specified, the steps in the foregoing embodiments should not be understood as a limitation on the order of execution.

1. An anti-falling apparatus, used in a transport robot, wherein the transport robot is capable of ascending or descending vertically along a rack rail on a rack, the transport robot comprises a braking mechanism, and the anti-falling apparatus comprises:
an acceleration measurement unit configured to measure an acceleration of the transport robot; and
a control unit configured to obtain the acceleration, wherein the control unit is further configured to detect, according to the acceleration, whether the transport robot falls on the rack rail, and when detecting that the transport robot falls on the rack rail, control the braking mechanism to apply braking, to stop the transport robot from falling.

2. The anti-falling apparatus according to claim 1, wherein the acceleration measurement unit is a three-axis acceleration sensor, and the acceleration comprises an X-axis acceleration, a Y-axis acceleration, and a Z-axis acceleration; and
the control unit is configured to calculate a resultant acceleration amplitude according to the X-axis acceleration, the Y-axis acceleration, and the Z-axis acceleration, and detect, according to the resultant acceleration amplitude, whether the transport robot falls on the rack rail.

3. The anti-falling apparatus according to claim 2, wherein the control unit is configured to determine that the transport robot falls on the rack rail when the resultant acceleration amplitude is less than a falling threshold, wherein the falling threshold is determined according to a difference between a gravitational acceleration value and a maximum descending acceleration value when the transport robot actively descends.

4. The anti-falling apparatus according to claim 3, wherein the falling threshold is equal to the difference between the gravitational acceleration value and the maximum descending acceleration value minus an allowable tolerance value, wherein the allowable tolerance value is a preset value.

5. The anti-falling apparatus according to claim 1, wherein the transport robot further comprises a switch unit electrically connected to the braking mechanism; and
the control unit is configured to be electrically connected to the switch unit; and the control unit is configured to send a control signal to the switch unit to control an action of the switch unit, to cause the braking mechanism to apply braking.

6. The anti-falling apparatus according to claim 5, wherein the braking mechanism is a brake of a motor of the transport robot; and
the control unit is configured to send the control signal to the switch unit to control the switch unit to be turned off, to cause the brake to apply braking, to cause the transport robot to stop at a current position on the rack rail.

7. The anti-falling apparatus according to claim 5, wherein holes are provided on the rack rail at intervals; and
the control unit is configured to send the control signal to the switch unit to control the action of the switch unit, to cause a braking member of the braking mechanism to extend to be engaged in the holes, so as to cause the transport robot to stop at a current position on the rack rail.

8. The anti-falling apparatus according to claim 1, wherein the transport robot further comprises a master control unit; and
the anti-falling apparatus further comprises a communication transceiver configured to be communicatively connected to the master control unit, wherein the communication transceiver is configured to send a falling prompt message to the master control unit when the control unit detects that the transport robot falls on the rack rail.

9. A transport robot, comprising:
a robot body capable of ascending or descending vertically along a rack rail on a rack, the robot body comprising a braking mechanism; and
an anti-falling apparatus connected to the robot body;
wherein the anti-falling apparatus comprises:
an acceleration measurement unit configured to measure an acceleration of the transport robot; and
a control unit configured to obtain the acceleration, wherein the control unit is further configured to detect, according to the acceleration, whether the transport robot falls on the rack rail, and when detecting that the transport robot falls on the rack rail, control the braking mechanism to apply braking, to stop the transport robot from falling.

10. The transport robot according to claim 9, wherein the acceleration measurement unit is a three-axis acceleration sensor, and the acceleration comprises an X-axis acceleration, a Y-axis acceleration, and a Z-axis acceleration; and
the control unit is configured to calculate a resultant acceleration amplitude according to the X-axis acceleration, the Y-axis acceleration, and the Z-axis acceleration, and detect, according to the resultant acceleration amplitude, whether the transport robot falls on the rack rail.

11. The transport robot according to claim 10, wherein the control unit is configured to determine that the transport robot falls on the rack rail when the resultant acceleration amplitude is less than a falling threshold, wherein the falling threshold is determined according to a difference between a gravitational acceleration value and a maximum descending acceleration value when the transport robot actively descends.

12. The transport robot according to claim 11, wherein the falling threshold is equal to the difference between the gravitational acceleration value and the maximum descending acceleration value minus an allowable tolerance value, wherein the allowable tolerance value is a preset value.

13. The transport robot according to claim 9, wherein the transport robot further comprises a switch unit electrically connected to the braking mechanism; and
the control unit is configured to be electrically connected to the switch unit; and the control unit is configured to send a control signal to the switch unit to control an action of the switch unit, to cause the braking mechanism to apply braking.

14. The transport robot according to claim 13, wherein the braking mechanism is a brake of a motor of the transport robot; and
the control unit is configured to send the control signal to the switch unit to control the switch unit to be turned off, to cause the brake to apply braking, to cause the transport robot to stop at a current position on the rack rail.

15. The transport robot according to claim 13, wherein holes are provided on the rack rail at intervals; and
the control unit is configured to send the control signal to the switch unit to control the action of the switch unit, to cause a braking member of the braking mechanism to extend to be engaged in the holes, so as to cause the transport robot to stop at a current position on the rack rail.

16. The transport robot according to claim 9, wherein the transport robot further comprises a master control unit; and
the anti-falling apparatus further comprises a communication transceiver configured to be communicatively connected to the master control unit, wherein the communication transceiver is configured to send a falling prompt message to the master control unit when the control unit detects that the transport robot falls on the rack rail.

17. An anti-falling device, used in a transport robot, wherein the transport robot is capable of ascending or descending vertically along a rack rail on a rack, the transport robot comprises a braking mechanism, and anti-falling device comprises: a processor, a memory, a communication interface, and a communication bus, wherein the processor, the memory, and the communication interface complete mutual communication by using the communication bus; and
the memory is configured to store executable instructions, wherein the executable instructions enable the processor to:
obtain an acceleration of the transport robot;
detect, according to the acceleration, whether the transport robot falls on the rack rail; and
control the braking mechanism to apply braking when detecting that the transport robot falls on the rack rail, to stop the transport robot from falling.
